(19) United States
(12) Patent Application Publication
(10) Pub. No.: US 2014/0188889 A1
(43) Pub. Date: Jul. 3, 2014

(54) Predictive Selection and Parallel Execution of Applications and Services

(71) Applicant: MOTOROLA MOBILITY LLC, Libertyville, IL (US)

(72) Inventors: Johannes Peter Wilhelm Martens, San Francisco, CA (US); Michael D. McLaughlin, San Jose, CA (US)

(73) Assignee: Motorola Mobility LLC, Libertyville, IL (US)

(21) Appl. No.: 13/769,462

(22) Filed: Feb. 18, 2013

Related U.S. Application Data
(60) Provisional application No. 61/747,560, filed on Dec. 31, 2012.

(51) Int. Cl. G06F 17/30

(52) U.S. Cl. CPC G06F 17/30598
USPC 707/740

(57) ABSTRACT

User input is entered or selected, and in response, the user input can be analyzed to determine a characteristic of the user input. The characteristic can describe the format, type, or content of the user input. The user input can be further analyzed to determine a category with which the user input is related. In response to the determined category, a set of predetermined or dynamically determined relevant applications can be determined. The set of the relevant applications can be based on user preferences, crowd-sourcing, and advertisements. The set of applications can then be executed in parallel, using the user input as input, such that results from the application are obtained quickly without user additional user input. The relevance of the results of the applications can be determined, and versions of the results can be displayed to a user in a ranked order according to the relevance of the results.

### BACKGROUND

With the proliferation of small, but powerful, portable computing devices, there has been an explosion of specialized applications and services that take advantage of the high performance network connectivity, location determination, cameras, and general computing power of such devices to provide timely and useful information to users for a wide range of purposes and situations. Although the abundance of choices of applications and services has provided users with a myriad of options and created a highly competitive marketplace, it has also created user confusion and a certain level of stasis with respect to the number of applications and services of which users are aware and actually use on a regular basis with any degree of success or efficacy.

In the mobile communication and computing arena, users can download and install small specialized applications, or “apps”, to their individual portable computing devices, e.g., smart phones, tablet computers, laptop computers, etc., to perform specific functions or engage in particular activities. Such functions and activities range from playing games and sharing photographs to banking and finding real estate properties. As used herein, the term application may refer to any type of standalone or Internet connected application, program, or subroutine executed in any layer in the computing environment, e.g., in the operating system, in the middleware layer, or as a top layer application. Due to the specific-purpose and atomic-nature of such stand-alone and Internet-connected applications, many real-world scenarios require a user to launch and use multiple applications and/or services to complete a real-world task, e.g., make a reservation for dinner at a restaurant and invite friends to the dinner.

In one example, a user might receive an email or short messaging service (SMS) message from a friend recommending or suggesting dinner at a particular restaurant. To read reviews of the restaurant to help the user decide if he/she would like to try the suggested restaurant, the user would need to either remember or copy the name of the restaurant, exit the email or SMS message application, and launch a restaurant review application, such as YELP®, that the user may know about or use on a regular basis. After reading the review in the restaurant review application, the user may then want to look at the location using a map application to determine where the restaurant is located. To look up the location, the user must exit the restaurant review application and launch a map application, at which point, the user may have to reenter or paste in the name or address of the restaurant. Once the user determines that he/she may want to try the restaurant, he/she may want to make a reservation at the restaurant using a restaurant reservation application, such as OpenTable®. To make the reservation, the user would need to exit the map application, launch the reservation application, and yet again, paste or enter in the name of the restaurant. Once the reservation is made, the user may wish to invite friends to join him/her at the restaurant via email. To do so, the user would have to exit the reservation application, launch the email application again, and compose an email with all the information discovered in each of the previously opened (and exited) applications manually.

While the above scenario is possible with conventional mobile computing operating systems and applications, such systems require that the user know the name of each application, the function and capabilities of each application, and know how to quickly launch the application from the user interface of his/her mobile computing device. Not only are such systems awkward and arduous to use to perform various everyday functions, such systems can also hinder, and in some scenarios prevent, a user from discovering new and useful applications or services already installed on, or otherwise available to, his/her mobile computing device. If the user does not know that an application exists for particular function, and does not actively go looking for it using a search engine, then it is unlikely that such a user will learn about or otherwise be exposed to the functionality and capabilities of various new applications and services.

### BRIEF DESCRIPTION OF THE DRAWINGS

FIG. 1 is a block diagram of a system for predictive and parallel execution of applications, according to various embodiments of the present disclosure.

FIG. 2 is a block diagram of a predicative application selector, according to various embodiments of the present disclosure.

FIG. 3 is a flowchart of a method for predictively providing applications with parallel execution, according to various embodiments of the present disclosure.

FIG. 4 is a flow chart of a method for automatically providing ranked results from predictively provided applications in response to text input, according to various embodiments of the present disclosure.

### DETAILED DESCRIPTION

Described herein are techniques for systems and methods for predicting, and executing in parallel, applications for accomplishing real-world tasks, in response to text input and other indications of user context. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Various embodiments of the present disclosure include methods, executed by an electronic device 103, that can include receiving user input, such as, voice data, or image data, via a first application, analyzing the user input to determine a characteristic of the user input, and, in response thereto, determining an associated category based on the characteristic. The associated category categorizes the user input according to one or more predetermined categories. Such embodiments can also include, determining a set of applications based on the associated category, where applications in the set of applications are determined to be relevant applications into which the user input can be input and are different from the first application, and wherein the associated category categorizes the user input according to one or more predetermined categories. Related embodiments can also include executing the set of applications, where the user input is available as an input to the set of applications.

Other embodiments of the present disclosure include non-transitory computer-readable storage media containing instructions that, when executed, control a processor of a computer system to be configured for receiving user input, such as text data, voice data, or image data, via a first application, analyzing the user input to determine a characteristic of the user input, and determining an associated category based on the characteristic of the user input. The determined associated category categorizes the user input according to one or more predetermined categories. Such embodiments can also include determining a set of applications based on the associated category, wherein applications in the set of applications are determined to be relevant applications in which the user input can be input and are different from the first application. The associated category categorizes the user input according to one or more predetermined categories. Related embodiments can also include executing the set of applications, wherein the user input is available as an input to the set of applications.

Various other embodiments of the present disclosure include an apparatus that can include one or more computer processors and a non-transitory computer-readable storage medium containing instructions, that when executed, control the one or more computer processors to be configured for receiving user input, such as text data, voice, data, or image data, via a first application, analyzing the user input to determine a characteristic of the user input, and determining an associated category based on the characteristic of the user input. The associated category categorizes the user input according to one or more predetermined categories. In related embodiments, the instructions can further control the processors for determining a set of applications based on the associated category, wherein applications in the set of applications are determined to be relevant applications in which the user input can be input and are different from the first application, and executing the set of applications, wherein the user input is available as an input to the set of applications.

Various embodiments of the present disclosure include a method, performed by a computing system, or other electronic device 103, for predictively determining and executing in parallel various relevant applications for accomplishing various tasks in response to internal and external contexts. Internal contexts can include text entered and/or selected using a user interface of an electronic device 103, such as a smart phone or tablet computer, as well as historical or trending usage of electronic device 103, e.g., a listing of recently launched applications or operating system level actions and tasks. External context can include a time or date, as well as physical geographic or relative location of the electronic device 103 and/or the user. As used herein the term “application” can refer to any program or service executed locally in an electronic device 103 or locally tethered device, or remotely in another computer system connected to the electronic device 103 by one or more electronic communication media.

In response to user input, such as a selection of text displayed by one or more active applications on a display device of an electronic device 103, various embodiments of the present disclosure can analyze the characteristics of the selected text to determine the structure and/or format of the user input. For example, such analysis can include recognizing that the selected text is referring to a time or date or a name. For example, the phrase, “the day after tomorrow,” can be analyzed to mean an actual date on the calendar relative to the day on which an email or SMS message containing the phrase was received or relative to the current date and time. Similarly, such analysis can also include recognizing selected or entered text as being a name, an address, a business, or other commonly known or used vernacular term. While many of the embodiments described herein are described in reference to the user input including text data, user input can include any type of data. For example, in addition to text data, voice data, voice recognition data, image data, video data, and any combination of thereof, can be included in the user input.

The initial analysis of the text data can also include executing an initial local query or search on data stored locally on the electronic device 103 to determine any direct matches with the text data. For example, an electronic device 103, such as a smart phone, can execute the query or search on the data associated with locally stored contacts, SMS text messages and/or email messages. If the search results in a direct match, or a large number of matches, then various embodiments of the present disclosure can determine that the text is highly relevant to the user and may determine the applications used to access the locally stored matching data on the electronic device 103 should be presented to the user in a list of potentially relevant results.

While, or after, the initial analysis is performed, various other embodiments of the present disclosure include querying or searching local and/or remote category databases to determine a category with which the text might be associated. For example, the text may include the title of a movie, therefore a search of the category databases can determine an associated category of the text data is “movies” or “movie titles.” Based on the determination of a category, various embodiments of the present disclosure can determine a predetermined and/or dynamically determine a set of various potentially applicable or relevant applications. Such sets of applications can be based on user preferences, crowd source opinions, advertisement space sales, and other factors that might indicate that a particular application might be applicable or helpful with respect to the particular category determined to be associated with the text.

Some or all of the applications determined to be associated or potentially relevant to the determine category can be executed in parallel. In response to running separate applications, various embodiments of the present disclosure can receive the results from the applications asynchronously, i.e., in the order in which results are returned or completed. In related embodiments, the results from the set of applications can be analyzed to determine the relevance of the results based on the strength of the results and/or other contexts of the user or the electronic device 103. The results from the set of applications can then be ranked according to the determined relevance of the results and displayed to the user according to the ranking. Such displays can include a link or other control operable by the user to launch the related application or view a more complete version of the results.

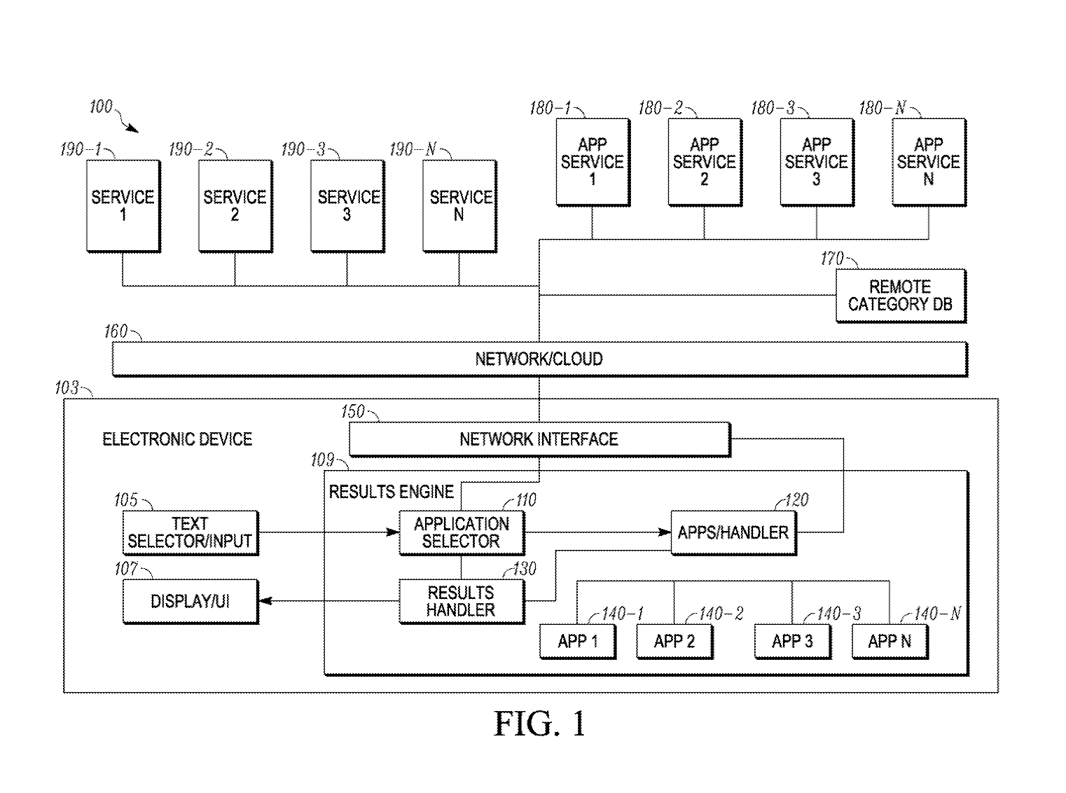

FIG. 1 illustrates a diagram of a system 100 for predictively determining sets of applications for parallel execution in response to one or more contexts, such as text data or location, according to various embodiments of the present disclosure. As shown, system 100 can include an electronic device 103 that includes a results engine 109, coupled to text selector/input device 105, display/UI device 107, and network interface 150. Electronic device 103 may include a smartphone, tablet device, laptop, set-top box, watch, eye-glasses, or other computer systems. In one embodiment, the results engine 109 can be coupled to network/cloud 160 through network interface 150. In such embodiments, the results engine can communicate with services 190 and application support services (application services) 180 coupled to the network/cloud 160.

Services 190 can include remotely hosted websites or search engines that can be accessed using a general purpose or non-specialized application, such as a web browser. Accordingly, services 190 can include backend processes that, in response to receiving input from the electronic device 103, perform various functions to generate results that are accessible via one or more universal or platform-agnostic computer readable languages, such as hypertext markup language (HTML). In contrast, application support services 180 can include remotely hosted backend applications and services that can be accessed using specialized applications. Such specialized applications can be locally executed on the electronic device 103 and may include user interfaces, security or encrypting functionality, or other specialized functionality that is specific to or required for accessing results or other information from an associated application support service 180. For example, a banking application associated with a particular bank or financial institution can include proprietary encryption routines for encrypting and/or verifying the credentials of a user before a user can access financial information from the particular bank or financial institution. Similarly, a mapping or navigation application associated with a particular map database can include a specialized reader for decoding proprietary compressed map data stored in the map database.

In yet other embodiments, results engine 109 can be coupled, via network interface 150 and network/cloud 160, to remote category database 170. In some embodiments, the results engine 109, text selector/input device 105, display/UI device 107 can be embodied in a combination of software, firmware, and hardware in one or more electronic devices 103. In related embodiments, the electronic device 103 can locally execute applications 140, using a local processor and memory. Such memory can include volatile and non-transitory computer readable media in the electronic device 103.

Text selector/input device 105 can include various types of standardized or specialized computer-user interface devices, such as touchscreens, keyboards, computer displays, voice (microphone/speaker), cameras, keyboards, proximity sensors, mice, styli, etc. In related embodiments, the text selector/input device 105 can include a graphical user interface (GUI) generator for displaying a GUI on the display device/UI 107. Such GUIs can include various types of text selection tools that a user can operate to indicate a selection of text displayed on device/UI device 107. In such embodiments, the text displayed on the device/UI device 107 can be generated by an active or a background application being run on electronic device 103. In other embodiments, the text selector/input device 105 can include a connection to one or more external applications that provide text data as output.

Network interface 150 can include various types of network interface cards and transceivers for communicating with the network/cloud 160. Accordingly, the network interface 150 and the network/cloud 160 can be configured to communicate with one another over various types of electronic communication protocols including, but not limited to, Wi-Fi, general packet radio service (GPRS), global system for mobile communications (GSM), enhanced data rates for GSM evolution (EDGE), 3G, 4G, 4G long-term expansion (LTE), worldwide interoperability for microwave access (WiMAX), Ethernet, the Internet, and other wireless and wired electronic communication protocols. In such embodiments, the network interface 150 and cloud/network 160 can allow electronic communication between the results engine 109 and services 190, application services 180 and the remote category database 170. In such embodiments, the services 190, application services 180, and remote category database 170 can be hosted and/or executed as a combination of software, firmware, and hardware in one or more remote server computers. Accordingly, the services 190, application services 180, and remote category database 170 can be, or be included in, memory or memory portions of remote computers or server computers.

In some embodiments, the results engine 109 can include a number of subcomponents or subroutines including, but not limited to, application selector 110, applications handler 120, and a results handler 130. Application selector 110, applications handler 120, and results handler 130 can be processors, or components of processors in the electronic device 103. In such embodiments, the application selector 110 can receive a selection of text from the text selector/input device 105. In response to receiving the text, the application selector 110 can analyze the characteristics of the text. Such analysis of the received text can include analyzing the structure, format, and content of the text. For example, the application selector 110 can determine that the selected text includes various types of data including, but not limited to, dates, names, locations, telephone numbers, websites. In such embodiments, the application selector can locally determine the type or format of the text. The application selector 110 can then send a command to the application handler 120 to execute a number of local applications 140. For example, the application selector 110 can instruct the application/service handler 120 to execute searches on local data stored on the electronic device 103, such as email messages, SMS messages, contact lists, address books, etc. In other embodiments, the application selector 110 can send a data request message the can include the text data to remote category database 170, via the network interface 150 and/or the network/cloud 160.

In such embodiments, the remote category database 170 can include a relational database of words, terms, key words, phrases, titles, names, etc. with specific categories that can categorize all or some of the text data received by the application selector 110. For example, the application selector 110 can receive the title of the movie. In situations in which the application selector 110 may not be able to determine locally that the random string of words in the text data indicates a movie category, remote category database 170 might recognize that some portion of the text data includes a movie title, and in response, send a response message to the application selector 110 indicating that the text data includes the context of the movie.

Once the application selector 110 analyzes or otherwise determines a particular category associated with the text data received from the text selector/input tool 105, the application selector 110 can determine a set of applications relevant to the category. Such sets of applications can include predetermined or dynamically determined sets of applications.

The application selector 110 can send a command message to the application/service handler 120 that includes instructions for executing the determined sets of applications. The application/service handler 120 can then execute the sets of applications using some or all of the selected or received text data as input. In some embodiments, the applications service handler 120 can execute each of the local applications 140, remote services 190, and application support services 180 in parallel, thus reducing the amount of time to receive the results from the applications. The application/service handler 120 can both asynchronously receive the results from each of the local and remote applications and send the results to the results handler 130. Results handler 130 can receive results from the various local and remote applications, determine the relevance of the results, and then rank the results according to the determined relevance of the results.

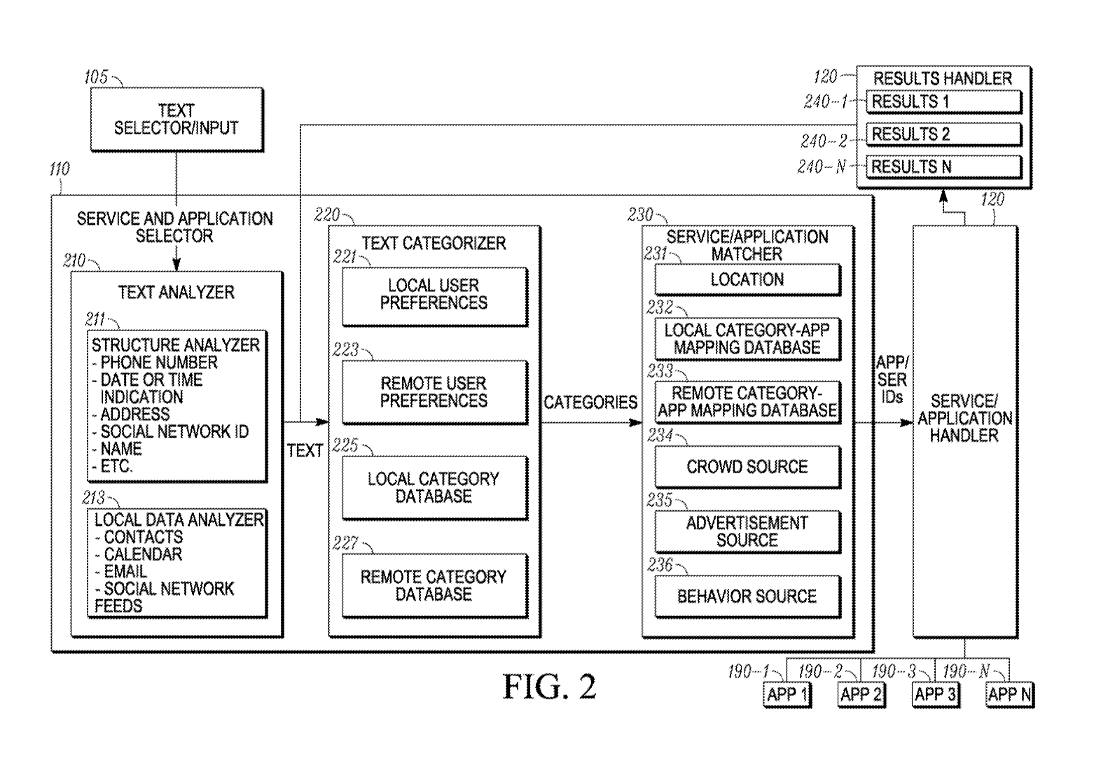

The functionality of the application selector 110 will now be discussed in more detail in reference to FIG. 2. As shown, application selector 110 can include a number of subcomponents such as text analyzer 210, text categorizer 220, and application matcher 230. The text analyzer 210 of the application selector 110 can receive text data from the text selector/input device 105. The text analyzer 210 can include a structure analyzer 211 and local data analyzer 213. The structure analyzer 211 can determine, based on a number of factors including, but not limited to, format, structure, syntax, etc. various characteristics of the input text data. For example the structure analyzer can determine whether the text data includes a telephone number, a conference call dial-in code, a date or time indication, an address, a social network identifier (social network ID), a postal tracking code, a barcode, a QR code, a URL/URI website address, an email address, a name, or other common or expected data type or format. The text analyzer 210 can also include the local data analyzer 213. In response to analysis performed by the structure analyzer 211, the local data analyzer 213 can determine whether or not to perform a search or query on locally stored data. The locally stored data can include tables and or data stores of contacts, calendars, email messages, social network feeds, and any other type of locally stored data specific to the electronic device 103 or a user of electronic device 103. The local data analyzer 213 can send commands to the operating system of electronic device 103 and/or another application 140 to perform the necessary searches or queries on the locally stored data. In response to the searches or queries, the local data analyzer 213 can receive a number of results for locally stored data that match the content of the text data. Such results can include indications of matching locally stored data that can be used in various embodiments of the present disclosure to indicate or weight a rank or relevance of the particular result.

When the text analyzer 210 completes the initial analysis of the text data, it can send the received text to the text categorizer 220. The text categorizer 220 can categorize the text using a number of local and remote functions, applications, services or other tools. In some embodiments, the text categorizer 220 can include a listing of predetermined local user preferences 221 and remote user preferences 223. In such user preferences 221 and 223, a user of the electronic device 103 can list a number of categories that should be considered for all text sent to the application selector 110. In embodiments that include remote user preferences 223, the remote user preferences 223 can be accessed on a remote data store or downloaded from the remote data store to a memory in the electronic device 103. For example a user can store a listing of categories that includes restaurants and movie titles as categories that other components and functions of the application selector 110 can reference for selecting sets of relevant applications. In this way, the user can specifically guarantee that a specific category will be considered whenever text is input into various embodiments of the present disclosure. In related embodiments, when entering or selecting text to input into the application selector 110, a user may dynamically select a listing of commonly used for recently used categories that might be relevant to the particular text. For example, while or after selecting text displayed on the display device of a smart phone, the text categorizer 220 can display a number of potential categories that the application selector 110 should consider in further processing of the text data. For instance, after a user selects a name of a person, the text selector 110 can display a number of choices of categories that the user commonly uses with reference to names, such as celebrities, actors, contacts, etc. The text categorizer 220 can then determine that the user preferred category should be considered when categorizing the text.

In some embodiments, the text categorizer 220 can reference, or otherwise access, the local and/or remote category database 225 and 227. Such category databases can include correlations between various words, terms, phrases, and other types of text data with generalized or specific categories. Such category databases can be maintained by the user of electronic device 103 or a remote service or website, or developed using various types of search engines and/or crowd sourced data mining services. Once the categorizer 220 determines one or more corresponding or related categories for the text data, it can send the determined categories to application matcher 230.

In response to the received categories from the text categorizer 220, the application matcher 230 can match the categories to one or more sets of previously or dynamically determined relevant applications. In some embodiments, the application matcher 230 can also consider the location 231 of the electronic device 103. For example, the application matcher 230 can request a location from a location determination system or device in electronic device 103, such as a global positioning system (GPS) device. In such embodiments, the determined location of electronic device 103 can be used to customize the application determined to match the particular category of text data.

In various embodiments, the application matcher 230 can include local and remote category-application mapping databases 232 and 233. The remote category-application mapping database 233 can be accessed over one or more networks and/or downloaded to the electronic device 103. Either or both of the category-application mapping databases 232 and 233 can be accessed to determine one or more sets of predetermined applications that are potentially relevant to the determined categories.

In various other embodiments, the application matcher 230 can use crowd sourced information 234 to determine applications that might be relevant to the text data and/or categories. For example, application matcher 230 can access crowd sourced information 234 on one or more social media networking sites or application marketplaces to determine which applications users have previously found to be helpful and/or relevant with respect to the text data and/or category. Crowdsourcing can include a process that outsources tasks or information collection to a distributed group of people. Crowdsourcing can include gathering information or task results from an undefined group of users rather than a specific user or entity.

In yet other embodiments, the application matcher 230 can include behavior source information 236. The behavior source information 236 can include historical and or recent user behavior information that can indicate the category of the text. For example, behavior source information 236 can include information regarding how a user of the electronic device 103 was previously looking at entertainment options, and in particular looking at movie times using one or more movie review applications. Such information can be used by the application matcher 230 to customize and or augment any determined set of applications in response to the categories. For example, if the user was recently using a specific movie review application, such information can be stored or reflected in behavior source information 236. Thus, if the text categorizer 220 determines that the text involves a movie title, then the application matcher can add the recently used movie review application to the set of applications determined by the aspects of the application matcher 230.

Once the application matcher 230 has determined a set of applications, it can send a request to the application handler 120 to execute the set of applications. In some embodiments, the request sent by the application matcher 230 to the application handler 120 can include a set of application names and/or identifiers. The application handler 120 can then prepare corresponding commands or requests to local applications 140 or remote applications 190 and any and all supporting services for such applications, i.e., the backend processes for providing data or results to the local and remote applications.

In response to the command or request to the applications, the application handler 120 can receive the results from each of the applications. In some embodiments, application handler 120 can then forward the results to the results handler 130. The results handler 130 can then determine the relevance of each of the results 240. In response to the determined relevance of each of the results, the results handler 130 can receive information from the text analyzer 210 indicating the existence of data that matches the text data in a local memory or data store of electronic device 103. If there is data in the local memory or data store that matches the text data, then the results handler can include a link to the data or the local application that services that data, in a listing of the results from the other applications 190 or 140.

In related embodiments, the results hander 120 can analyze the results 240 returned from the set of applications to determine the relevance of the results. In some embodiments, the results handler 130 can determine corresponding relevance scores based on results. Based on the relevance scores, the results handler can rank the results for display to a user.

Once the results are received by the results handler 130, links to the application, a preview version of the results, or some combination thereof, can be displayed to the user. The application selector 110 can monitor the user's interaction with the list of ranked results to determine whether the user selects or views one or more of the ranked results, i.e., whether the user launches one or more of applications that returned the results in order to view the full version of the results.

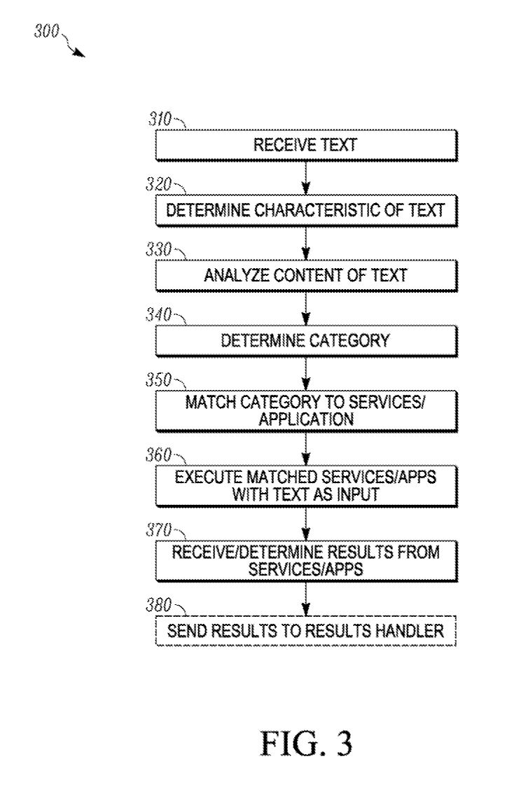

FIG. 3 is a flowchart of a method 300 for predicting potentially relevant applications in response to a given context of the user or electronic device 103. In some embodiments, the context of the user or the electronic device 103 can be determined using text data. In such embodiments, the method 300 can begin by receiving text from one or more applications or users in action 310. In response to receiving the text, various embodiments of the present disclosure include automatically performing the remainder of the actions of method 300. In such embodiments, the steps of method 300 can be performed automatically, or as a background process in an electronic device 103, in response to receiving the text and without additional user input.

In some embodiments, one or more characteristics of the received text can be determined in action 320. Determining the characteristics of the received text can include analyzing the format, content, structure, syntax, or context of the text. For example, the application selector 110 can determine that the text is of a specific format, e.g., a name, an address, the date, time, or other expected or frequently used format of information. In other embodiments, the application selector 110 can interpret or translate the content of the text to determine actual or inferred meaning from the text. For example, a phrase in German can be translated into a phrase in English or any other language.

The determination of the characteristic of the text can then be used to analyze the content of the text in action 330. Analyzing the content of the text can include determining the meaning of individual words, terms, phrases, or keywords, etc., in the text data. In some embodiments, analyzing the contents of the text can also include determining defined meaning, implicit meaning, inferred meaning, and explicit meaning of the text data. Such meanings can then be used to match the text data to general or specific concepts or topics.

In response to the analysis of the content of the text, a category with which to match the text data can be determined in action 340. In related embodiments, more than one category for a particular set of text can be determined. For example, the text may include keywords such as “shopping” and “electronics.” Such text, depending on the determined meaning, can be associated with categories such as shopping for electronics, electronic devices 103 for shopping, shopping on the Internet, etc. In some embodiments, the categories that are determined to match the text can be identified by various systems and formats of category identifiers. Such category identifiers can include, but are not limited to, category numbers, category titles, or category descriptions.

In related embodiments, a local or remote category database can be queried or accessed. Such category databases can include specialized databases or services specifically designed to relate words, phrases, and keywords in text with various categories. Various category databases can be designed to include both predetermined and dynamically determined categories for various text based on a number of factors including, but not limited to, explicit definitions, iterative consumer or user feedback, dictionaries, thesauruses, crowdsourcing data, etc.

In some embodiments, the application selector 110 can ask for user feedback to find to or clarify the categories with which the text should match. In reference to the example discussed above regarding the terms “shopping” and “electronics” in the text, the application selector 110 can generate a prompt to a user to clarify which of the multiple categories a user might find to be the most useful. For example, the application selector 110 can prompt the user to select from the categories of shopping for electronics, electronic devices 103 for shopping, or shopping on the Internet.

With the category matched to the text, the category can be matched to one or more sets of applications determined to be relevant or useful in action 350. In some embodiments, a category-application match database that includes various associations between categories and applications can be accessed. Such category-application databases can include entries that associate one category with multiple applications. Accordingly, text that is determined to match with multiple categories match the multiple applications that are determined to be associated with the multiple categories. In some embodiments, each category can be associated with a set of applications. In other embodiments, each category can be associated with a listing of application identifiers. In any of such embodiments, the applications associated with any given category can be predetermined by user, a search engine, a specialized service, or other entity having insight regarding which applications might be useful for particular category. Accordingly, multiple local and remote resources can be accessed for determining the sets of applications that might be relevant to a user who is interested in a particular category.

In action 360, any or all of the applications that are determined to match the categories associated with the text data can be executed. In some embodiments, it is advantageous for matching applications to be run in parallel in order to decrease the amount of time required to receive the results from the applications. In such embodiments, commands to execute each of the applications can be issued simultaneously or in rapid sequence (nearly simultaneously) in response to receiving the single instance of the text. Executing any or all of the applications determined to match the category or the text data can occur without further user interaction or additional user input. Accordingly, the applications can be run automatically and quickly in order to provide a user with as many options of relevant results as possible. Such features of various embodiments of the present disclosure are particularly advantageous over conventional information navigation systems which require a user launch each application that the user may know to be applicable, enter the text data, and then wait for the results from each particular application in series. By executing any or all of the sets of matching applications, embodiments of the present disclosure can be significantly faster and more effective than the iterative process of launching, executing, and receiving results from multiple applications separately. In addition, the embodiments of the present disclosure can be significantly more convenient to the user, because such embodiments can be performed or implemented in background processes and performed automatically in response to receiving text data and in the absence of additional user input.

In response to executing the applications, the results from each of the applications can be received in action 370. Due to the differences in execution and or retrieval time of the local and remote applications, the results from each of the applications can be received asynchronously. Accordingly, the results from each of the applications can be received at different points in time. In action 380, the results from each of the applications can optionally be sent to results handler to determine the relevance of each result and a possible ranking in which the returned results will be displayed to the user.

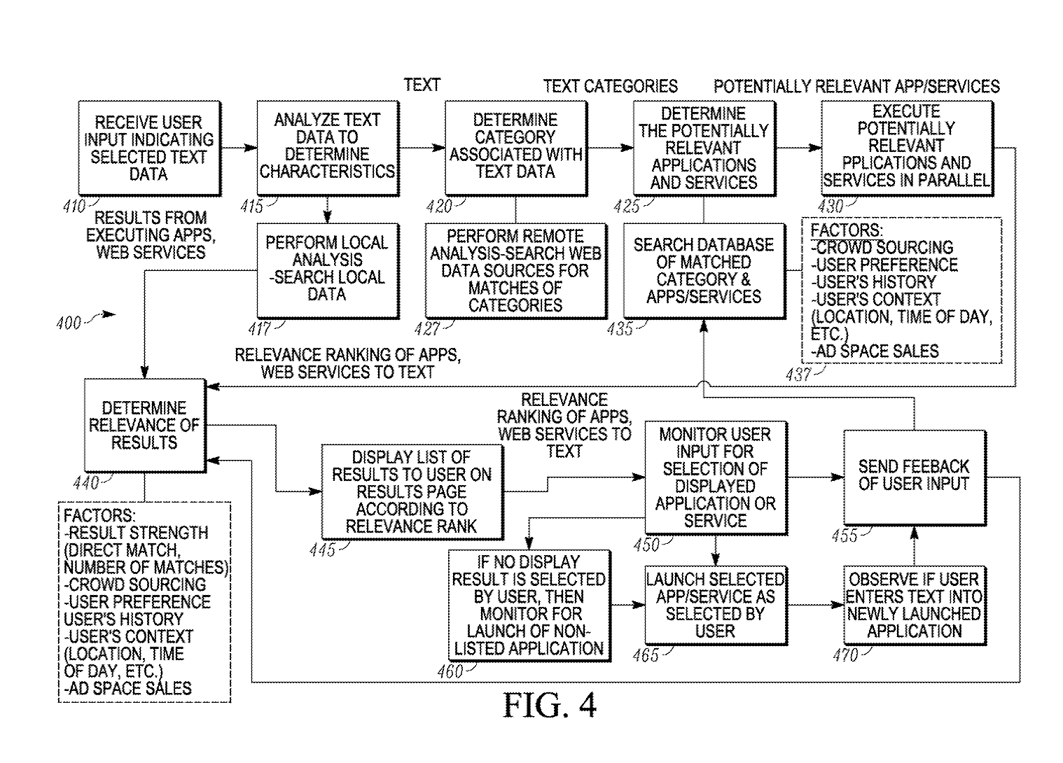

FIG. 4 is a flowchart of a method 400 for improving user interactions with various electronic devices 103, according to various embodiments of the present disclosure. Accordingly, FIG. 4 also shows a data flow among the various actions or processes of electronic device 103 according to various embodiments of the present disclosure. In block 410, electronic device 103 can receive text as input. In some embodiments, receiving text as input can include receiving an indication of a selected piece of text. In other embodiments, receiving the text as input can include performing voice recognition on voice input into the electronic device 103. In such embodiments, a voice recognition application can be executed on real time voice data or on digital and analog recordings of voice data.

In yet other embodiments, the text data can be embedded in an image or image data displayed on a display device of the electronic device 103. In such embodiments, optical character recognition (OCR) operations, and other text extraction operations, can be performed to extract the text data from the image data. For example, some applications perform their own image rendering and do not output text data to the operating system, the graphics engine, or the display. In related embodiments, the image output to the display of electronic device 103 can be captured using various techniques for print-screens or screen captures. Once the image of the screen is captured, the text extraction operation can be performed to extract text that can be input for block 410.

In another embodiment, electronic device 103 may be equipped with a camera device that can be used to capture an image of a scene that includes text information, e.g., a photograph of a book, a photograph of a street sign, a photograph of a storefront sign. Additionally, photographic and video sources (e.g. from a gallery, from a website such as YouTube™, Facebook™, etc.) can be viewed on the electronic device 103 and those images (scenes) can be used as a “captured image”. Once the image is captured, various text extraction operations can be performed to extract the real world text data directly from the captured image. Extraction of the text and other data from analysis of information and images displayed on the electronic device 103 can occur continuously or in real time, such as in a background operation. Analysis of all or some of the information displayed on a display device of the electronic device can occur automatically or in response to user input to analyze the information on the display. Such text or other information can then be received as input in block 410.

Once the text data is determined, it can be sent to block 415. In block 415, the text data is analyzed to determine the character of the text data. Various aspects of the text data, including the character of the text data, can be analyzed to determine what kind of information might be included in the text data. For example, the text data can be determined to include a phone number, a time or date, a name, an address, or a social media login identifier. If the analysis of block 415 determines that the content of the text data includes information that might be found in data stored locally on the electronic device 103, or in another device local to the location of electronic device 103, such as secondary or ancillary display, control, or input device, the text data can be sent for analysis in block 417. The secondary or ancillary display, control, or input device can include devices, such a wristwatch or glasses connected through a local wired or wireless connection to the electronic device 103 to share user input/output, information, computing resources, or networking resources. For example, the secondary display and control device and electronic device 103 can include a wristwatch having its own display, microphone/speaker and user interface (e.g. voice activated, touch-screen activated, etc.) that is connected to a smartphone via a short-range Bluetooth data connection.

In block 417, a search can be performed on the local data. Such local data can include local client data including information regarding locally stored contacts, calendar entries, call logs, email, SMS messages, etc. The determination of matching data stored locally on electronic device 103 can be used in later processes to determine or weight the relevance of the results returned from various applications.

Once the initial analysis of the input text data is complete, the actual text can be sent to block 420 to determine a category that matches the text. The determination of a category can be based on information in text-category database 170 where the text is determined to match terms such as, keywords, phrases, or titles, with categories. For example, if the input text data is determined to be a name, the analysis of the actual text can determine the text is associated with a celebrity, movie star, politician, and/or be associated with the name of a book or a movie. At 427, various embodiments of the present disclosure can use both locally stored and remotely hosted text-category databases that can be created, maintained, or augmented by the user of the local electronic device 103 and/or other users or entities.

Once one or more categories that match the text are determined, the text categories can be sent to block 425 to determine an initial set of relevant applications that have been predetermined or dynamically determined to be potentially relevant to the determined category. In some embodiments, the determination of the initial set of potentially relevant applications can be based on a search of one or more databases of a category-application databases at block 435. Such databases can be stored locally on electronic device 103 and/or hosted on a remote server accessible over one or more communication standards. In related embodiments, each of the category-application databases can include a listing of associated categories applications based on a number of factors at block 437. The factors can include input from various forms of data including, but not limited to, crowd sourced information, user preference information, user's history of the electronic device 103, content associated with the user, as well as other objective information such as time, location, and date.

In related embodiments, the initial set of potentially relevant applications can be determined in view of paid advertising. For example, in consideration of the user's recent use of electronic device 103, which can include the user's location, recent search engine searches, recently run applications, as well as any other potentially relevant information, new and previously uninstalled or unused applications that may be potentially relevant to the category or input text can be suggested and or automatically run to return results that use the text data as input. For example, a user may have recently used a navigation application on his or her smart phone to find directions to a local hardware store. Once the user is determined to be in the parking store of the hardware store, and the electronic device 103 has determined that the user is walking in the parking lot toward the store, various embodiments of the present disclosure can use such information for informing the determination of the initial set of potentially relevant applications. In such embodiments, if the user or an application inputs or otherwise indicates a selection of text data regarding a particular material or tool that might be found in the hardware store, block 435 can be used to suggest an application that might be downloaded and/or executed on the user's smartphone to help him/her find what he/she is looking for in the hardware store. For example, the particular hardware store to which the user is walking might have published an application specific for that hardware store. Such an application might show the user where various materials and tools are located within the store. Similarly, manufacturers of items in the store can also use such user specific information to advertise or provide applications to the user in response to the user's situation (e.g. location near or in the store) or to the entry of specific text data or in a combination of these factors.

Just as the text can match with one or more categories, the matched sets of potentially relevant applications can match with multiple categories. Accordingly, the initial set of potentially relevant applications can include multiple subsets of applications associated with multiple categories. The sets of potentially relevant applications can then be presented to the user either as a choice to operate or execute a particular application in other embodiments, some or all of the entire sets of the initial sets of potentially relevant applications can be executed automatically without further user input in block 430. Such embodiments can thus provide the user with a set of results from each of the applications using the text data as input without the user manually executing each of the applications with the text data as input. Block 430 can also include receiving the results for each of the applications simultaneously in a single message or asynchronously as each of the applications provide the results. In particular the results from executing the applications using the text data as input can be sent to block 440 to determine the relevance of the results. To determine the relevance of the results, the results can be analyzed to determine the strength of the results. In some embodiments, the strength of the results can be determined by various functions that generate a related relevance score. In such relevance score operations, the higher the relevance score, the more relevant results.

In related embodiments, at 440, the relevance of the results can be determined in consideration of various factors. Such factors can include, but are not limited to, the results from the analysis of the input text data in blocks 415 and 417 in view of the locally stored data on electronic device 103. For example, if the results from a social media networking search application returns the same results of a person's name found in context data stored in electronic device 103, then those results might be determined to be highly relevant. The factors can also include weighting values based on information from crowdsourcing information, user preferences, user's history, user's context, as well as advertisement space. For example, an operator or service provider providing services to the electronic device 103 implementing various embodiments of the method 400 can sell priority listing rights to an advertiser such that the results from their application can be determined to be highly relevant with respect to the matched category or text data.

Results from various applications can be ranked according to determine relevance results. The results, along with a link or other control for invoking or launching the associated application that provided the results, can be displayed to the user according to the ranked order in block 445. Once the ranked results are displayed to the user, electronic device 103 can receive a user selection of one of the displayed results to launch the application or view the full version of the results from the application in block 450. In response to the selection of results, electronic device 103 can launch the selected application or display the full version of the results in block 465. In related embodiments, the user can be presented with a back button to return the list of ranked results.

On occasion, the initial set of potentially relevant applications and/or the determination of the relevance of the results from the applications can be inaccurate or not especially appropriate or applicable to the user's intended use of the text data. In such situations, electronic device 103 can monitor user input to determine if none of the displayed ranked results are selected by the user in block 460. In such scenarios, the user may exit from the display of the ranked results and launch a completely different non-displayed application. The non-displayed application can then be launched in block 465. In various embodiments, electronic device 103 can determine if the user pastes or enters the same text data into an application that was not previously displayed in the ranked results in block 470. In such embodiments, the information regarding the application that was actually used by the user, e.g., an association between the manually entered text data and the application that was ultimately launched, can be used in analysis for determining future relevance of the particular application that the user did use with similar or related text data in box 455. In such embodiments, electronic device 103 can learn which applications the user of the electronic device 103 actually uses or prefers when certain text data is entered or otherwise indicated. In one embodiments, electronic device 103 can provide the user with explicit prompts for user feedback. For example, in the event that the user exits the ranked listing of potentially relevant results without selecting any of the results or using any of the associated applications provided in block 460, then part of the observation of user input of block 470 can include prompting the user for an indication of an application that the user thinks or knows to be relevant to the text data. In other embodiments, the observation of user input in block 470 can be automatic and completed as a background process without the user being aware or requiring any additional user input. The automatic observation or monitoring of user input after the user exits or dismisses the listing of potentially relevant results can be limited to a predetermined amount of time, limited to a predetermined number of user input entries, or limited to user input that includes or is related to the text data that initially initiated the processes beginning at block 410. While observing user input for similar or related text data to be entered into another application, the system can record any application into which the user might enter the text data and analyze the results to determine the relevance or strength of the returned results. The information regarding the recorded application, e.g., an application name or identifier, and information regarding the strength of the results, e.g., the result relevance score, can be provided to block 455 to increase the basis of the crowd sourced data and augment the particular user's preferences. The augmented crowd sourced data and the user preferences can then be used to update the category-application database.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by an electronic device, user input via a first application;
analyzing, by the electronic device, the user input to determine a characteristic of the user input;
determining, by the electronic device, an associated category based on the characteristic of the user input, wherein the associated category categorizes the user input according to one or more predetermined categories;
determining, by the electronic device, a set of applications based on the associated category, wherein applications in the set of applications are determined to be relevant applications in which the user input can be input and are different from the first application, and wherein the associated category categorizes the user input according to one or more predetermined categories; and
executing, by the electronic device, the set of applications, wherein the user input is available as an input to the set of applications.

2. The method of claim 1, wherein the user input comprise text data,
wherein analyzing the user input to determine the characteristic of the user input comprises analyzing the text data to determine a characteristic of the text data, and
wherein determining the associated category is further based on the characteristic of the text data.

3. The method of claim 2, wherein determining the associated category based on the characteristic of the user input further comprises:
sending, from the electronic device, a request message comprising the text data to a remote text-category database comprising a plurality of a text-category association records, wherein each of the plurality of text-category association records comprise at least one term, used for matching the text data, associated with at least one category; and
receiving, by the electronic device, in response to the request message, a response message comprising a plurality of matching categories, wherein the plurality of matching categories comprise categories from a portion of the plurality of text-category association records determined to include terms that match the text data.

4. The method of claim 2, wherein determining the associated category based on the characteristic of the text data further comprises referencing a local text-category database comprising a plurality of a text-category association records, wherein each text-category association record comprises at least one term, used for matching the text data, associated with at least one category.

5. The method of claim 2, wherein determining the associated category based on the characteristic of the text further comprises referencing a set of user preferences comprising a plurality of user-defined text-category associations, wherein each of the plurality of user-defined text-category associations comprises at least one term, used for matching the text data, associated with at least one category.

6. The method of claim 1, wherein analyzing the user input to determine the characteristic of the user input comprises determining a structure associated with the user input, wherein the structure describes a type of content included in the user input.

7. The method of claim 6, wherein the structure comprises indications of time, date, proper name, or location.

8. The method of claim 1, wherein analyzing the user input to determine the characteristic of the user input comprises accessing one or more local data stores containing data associated with a user of the electronic device to determine local data, associated with data types, in the local data stores that matches the user input, wherein the data types are used to define the characteristic of the user input.

9. The method of claim 1, wherein the set of applications comprises a local application configured to operate on a set of data stored in a memory of the electronic device.

10. The method of claim 1, wherein the set of applications comprises an application configured to call a remote application executed on a remote server.

11. The method of claim 10, wherein the remote application, when executed, operates on a set of data stored on a remote data store in response to receiving the user input as the input.

12. The method of claim 1, wherein executing the set of applications comprises executing at least a portion of the set of applications in parallel.

13. The method of claim 1, wherein executing the set of applications comprises executing at least a portion of the set of applications as background processes in the absence of additional user input.

14. The method of claim 1, wherein determining the set of applications based on the associated category comprises referencing a crowd-sourced data store comprising a plurality of category-service set association records based on behaviors of a plurality of users in response to the user input, wherein each of the category-service set association records comprises a category identifier associated with at least one set of applications determined in response to the behaviors of the plurality of users, and wherein the category identifier is used to match the associated category.

15. The method of claim 1, wherein determining the set of applications based on the associated category comprises referencing one or more data stores of category-service set association records, wherein each of the category-service set association records comprises a category identifier associated with at least one predetermined set of applications, wherein the category identifier is used to match the associated category.

16. The method of claim 15, wherein the one or more data stores of category-service set association records comprises a user behavior data store comprising a plurality of category-service set association records, wherein each of the plurality of category-service set association records is based on previous behavior of a user associated with the electronic device, that included the associated category.

17. The method of claim 15, wherein the one or more data stores of category-service set associations comprises a keyword advertisement data store comprising a plurality of category-service set association records, wherein at least one of the plurality of category-service set association records comprises a category identifier associated with at least one predetermined set of applications, wherein the category identifier comprises a predetermined advertisement keyword and is used to match the associated category.

18. The method of claim 1, wherein the first application comprises an optical character recognition (OCR) application, and wherein the user input comprises text data selected from output from the OCR application.

19. A non-transitory computer-readable storage medium containing instructions that, when executed, control a processor of a computer system to be configured for:
receiving user input via a first application;
analyzing the user input to determine a characteristic of the user input;
determining an associated category based on the characteristic of the user input, wherein the associated category categorizes the user input according to one or more predetermined categories;
determining a set of applications based on the associated category, wherein applications in the set of applications are determined to be relevant applications in which the user input can be input and are different from the first application, and wherein the associated category categorizes the user input according to one or more predetermined categories; and
executing the set of applications, wherein the user input is available as an input to the set of applications.

20. An electronic device comprising:
one or more computer processors; and
a non-transitory computer-readable storage medium containing instructions, that when executed, configure the one or more computer processors to:
receive user input via a first application;
analyze the user input to determine a characteristic of the user input;
determine an associated category based on the characteristic of the user input, wherein the associated category categorizes the user input according to one or more predetermined categories;
determine a set of applications based on the associated category, wherein applications in the set of applications are determined to be relevant applications in which the user input can be input and are different from the first application, and wherein the associated category categorizes the user input according to one or more predetermined categories; and
execute the set of applications, wherein the user input is available as an input to the set of applications.
